(19) United States
(12) Patent Application Publication
(10) Pub. No.: US 2025/0324175 A1
(43) Pub. Date: Oct. 16, 2025

(54) PROCESSING APPARATUS, IMAGE PICKUP APPARATUS, PROCESSING METHOD, AND STORAGE MEDIUM

(71) Applicant: CANON KABUSHIKI KAISHA, Tokyo (JP)

(72) Inventor: TAKESHI OGAWA, Tokyo (JP)

(21) Appl. No.: 19/073,661

(22) Filed: Mar. 7, 2025

(30) Foreign Application Priority Data
Apr. 12, 2024 (JP) 2024-064905

(51) Int. Cl. H04N 25/771; G06F 1/03; H04N 25/674

(52) U.S. Cl. CPC H04N 25/771; G06F 1/03; H04N 25/674

(57) ABSTRACT

A processing apparatus includes a memory storing first data, in which information for each pixel position on an image sensor is stored in a first array in an order from an optical axis of an imaging optical system toward a periphery or from the periphery toward the optical axis, and second data, in which the first data is stored in a second array regarding an optical condition, and a processor configured to calculate third data using a plurality of consecutive adjacent data of a part of the first data in the second data, and store in the memory the third data in a third array different from the first array.

### BACKGROUND

### Technical Field

The present disclosure relates to a processing apparatus, an image pickup apparatus, a processing method, and a storage medium.

### Description of Related Art

The focus detecting method using an imaging-surface phase-difference method that performs pupil division using an image sensor has conventionally been known. In a lens interchangeable type camera, some characteristics are determined according to both the optical characteristics of the interchangeable lens and the optical characteristics of the image sensor. In particular, the base length between focus detecting pixels is necessary to calculate the focal plane, and the above characteristics are to be calculated.

Japanese Patent Laid-Open No. 2019-219576 discloses a method for calculating a conversion coefficient that converts an image shift amount of pupil- divided images into a defocus amount using information on a light shield shape of a lens frame for each lens. Parameters for determining the conversion coefficient for the light shield shape are stored as a table in a memory, and parameters corresponding to the determined light shield shape are retrieved from the memory and used for calculation. Japanese Patent Laid-Open No. 2012-65187 discloses a method for correcting an image by performing deconvolution processing using a restoration filter stored in a memory. In Japanese Patent Laid-Open Nos. 2019-219576 and 2012-65187, the necessary parameters are stored in the memory.

The methods disclosed in Japanese Patent Laid-Open Nos. 2019-219576 and 2012-65187 require different parameters for each pixel position, and even in a case where optical conditions such as a pixel position, an F-number, and a PO value are discretely stored and interpolation is performed using them, the capacity of the table becomes huge. In a case where the optical conditions are discretely stored, pixel positions, F-numbers, and PO values must be interpolated, and therefore, for four interpolation pixel positions corresponding to one pixel position, two F-numbers for interpolation and two PO values for interpolation, a total of 16 parameters are to be interpolated.

The number of focus detecting points that can be measured simultaneously has recently increased, and the frame rate has also increased. Then, it is to perform a large amount of coefficient calculations for distance maps and distance images, and the number of table lookups becomes enormous. When focus detecting calculations are performed, a large amount of traffic occurs in the DRAM in which the table is stored due to image development processing, etc., and table lookups occur during these long burst transfers. As a result, the throughputs of both the development processing and the focus detecting processing deteriorate.

### SUMMARY

A processing apparatus includes a memory storing first data, in which information for each pixel position on an image sensor is stored in a first array in an order from an optical axis of an imaging optical system toward a periphery or from the periphery toward the optical axis, and second data, in which the first data is stored in a second array regarding an optical condition, and a processor configured to calculate third data using a plurality of consecutive adjacent data of a part of the first data in the second data, and store in the memory the third data in a third array different from the first array. An image pickup apparatus having the above processing apparatus, a processing method corresponding to the above processing apparatus, and a storage medium storing a program that causes a compute to execute the above processing method also constitute another aspect of the disclosure.

Further features of the disclosure will become apparent from the following description of embodiments with reference to the attached drawings.

### BRIEF DESCRIPTION OF THE DRAWINGS

FIGS. 1A and 1B illustrate an array in raster order.

FIG. 2 is a block diagram of an image pickup apparatus according to a first embodiment.

FIG. 3 is a sectional view of each pixel on an image sensor in the first embodiment.

FIG. 4 explains a base length in the first embodiment.

FIG. 5 explains a light shield shape in the first embodiment.

FIG. 6 explains a position on an imaging surface and lens information in the first embodiment.

FIGS. 7A and 7B explain interpolation in the first embodiment.

FIGS. 8A and 8B are flowcharts illustrating the procedure for creating a defocus map in the first embodiment.

FIG. 9 explains an array order corresponding to pixel positions in the first embodiment.

FIGS. 10A and 10B explain a difference between a raster array and an array diagram in distance order from the optical axis.

FIG. 11 explains a lens information map and a lookup (reference) table map in the first embodiment.

FIG. 12 explains an array order corresponding to pixel positions in a second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### FIRST EMBODIMENT

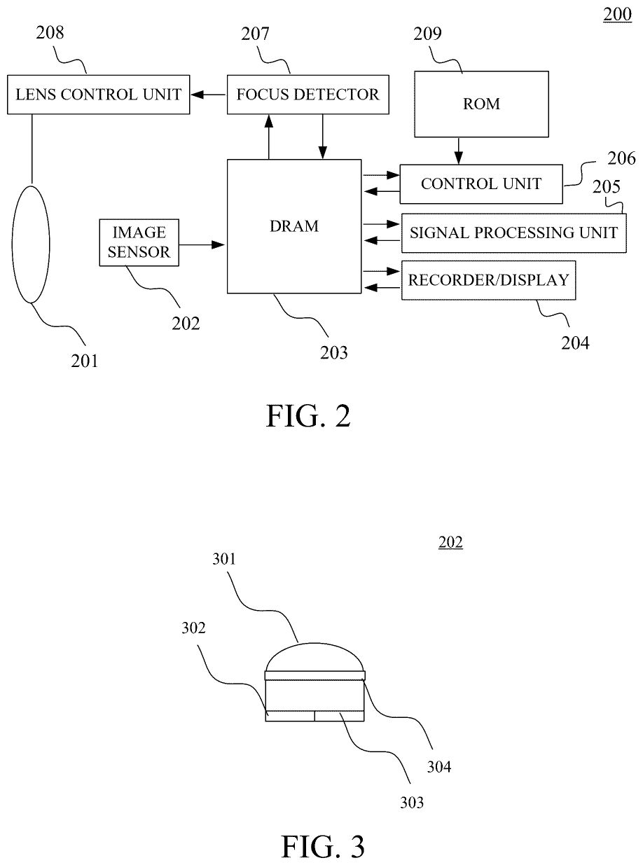

Referring now to FIG. 2, a description will be given of an image pickup apparatus (processing apparatus) 200 according to a first embodiment of the present disclosure. FIG. 2 is a block diagram of the image pickup apparatus 200. The image pickup apparatus 200 includes an imaging optical system 201, an image sensor 202, a recorder/display 204, a signal processing unit 205, a control unit 206, a focus detector 207, and a lens control unit 208. The focus detector 207 is a processing unit that has a function of creating a defocus map. The image pickup apparatus 200 also has a Dynamic Random Access Memory (DRAM) 203 and a Read Only Memory (ROM) 209. The DRAM 203 and the ROM 209 are memories that store various data such as a control program and a parameter table that are used by the control unit 206 or the focus detector 207.

The image sensor 202 is a photoelectric conversion element such as a Complementary Metal-Oxide-Semiconductor (CMOS) sensor or a Charge Coupled Device (CCD) sensor. The image sensor 202 photoelectrically converts an optical image formed by the imaging optical system 201 and outputs an imaging signal to the DRAM 203. The control unit 206 controls the entire image pickup apparatus 200 (entire system). The signal processing unit 205 processes the imaging signal stored in the DRAM 203 and converts it into image information (image data). The recorder/display 204 displays or records the image data stored in the DRAM 203. The focus detector 207 processes the imaging signal stored in the DRAM 203 and performs focus detection. The lens control unit 208 controls at least one lens (lens unit) that constitutes the imaging optical system 201 based on a signal from the focus detector 207. The ROM 209 stores control programs operated by the control unit 206 and the focus detector 207, as well as a parameter table having the data structure according to this embodiment.

The control unit 206 controls the entire system of the image pickup apparatus 200 based on user operations via an operation unit (not illustrated). In a case where the system is started, the control unit 206 transfers the control program and parameter table from the ROM 209 to the DRAM 203, starts the imaging optical system 201 and the image sensor 202, and transfers the output of the image sensor 202 to the DRAM 203.

The signal processing unit 205 reads the output of the image sensor 202 from the DRAM 203, and writes the image data that has been subjected to signal processing back to the DRAM 203. The recorder/display 204 reads the image data written by the signal processing unit 205 and displays it on a display unit (not illustrated). At the same time, the focus detector 207 reads the output of the image sensor 202, performs focus detection, and controls the lens control unit 208 for focusing.

The image sensor 202 has a first focus detecting pixel that receives a light beam transmitting through a first pupil partial area in the imaging optical system 201, and a second focus detecting pixel that receives a light beam transmitting through a second pupil partial area in the imaging optical system 201 that is different from the first pupil partial area. The focus detector 207 calculates an image shift amount using a first focus detecting signal (A image signal) generated from a light reception signal of the first focus detecting pixel and a second focus detecting signal (B image signal) generated from a light reception signal of the second focus detecting pixel. The focus detector 207 then calculates a defocus amount using the image shift amount and a conversion coefficient.

A description will now be given of the pixel structure of the image sensor 202 with reference to FIG. 3. FIG. 3 is a sectional view of each pixel (pixel unit) of the image sensor 202. In FIG. 3, reference numeral 301 denotes a microlens, reference numeral 304 denotes a color filter, and reference numerals 302 and 303 denote photoelectric converters. Thus, two photoelectric converters 302 and 303 are arranged as two divided pixels (first focus detecting pixel and second focus detecting pixel) corresponding to a single microlens 301. Thereby, two pupil-divided image signals (first focus detecting signal (A image signal) and second focus detecting signal (B image signal)). The A image signal and the B image signal are stored in the DRAM 203, and then added by the signal processing unit 205 to be used as image data. The A image signal and the B image signal are also used to detect the image shift amount during correlation calculation by the focus detector 207.

Once the image shift amount is known, it can be converted into a defocus direction and a defocus amount, and the lens can be driven according to the defocus amount for focusing. Here, in order to calculate the defocus amount from the image shift amount, a coefficient (conversion coefficient) is required to convert the image shift amount into the defocus amount.

A description will be given of a base length with reference to FIG. 4. FIG. 4 explains the base length. Reference numeral 403 denotes a pixel unit illustrated in FIG. 3, reference numeral 401 denotes an imaging optical system, reference numeral 402 denotes a principal ray of the imaging optical system, and reference numerals 404 and 405 denote principal rays for the divided pixels. Reference numeral 407 denotes a defocus amount, which corresponds to a distance between the position where the divided principal rays 404 and 405 intersect and pixels, i.e., the imaging surface. The principal rays 404 and 405 are determined by the center of gravity of the light rays incident on the divided pixels. Reference numeral 406 denotes a base length, which corresponds to a distance between the two centers of gravity of the light rays incident on the two divided pixels. The defocus amount 407 can be calculated using the base length 406 and the image shift amount.

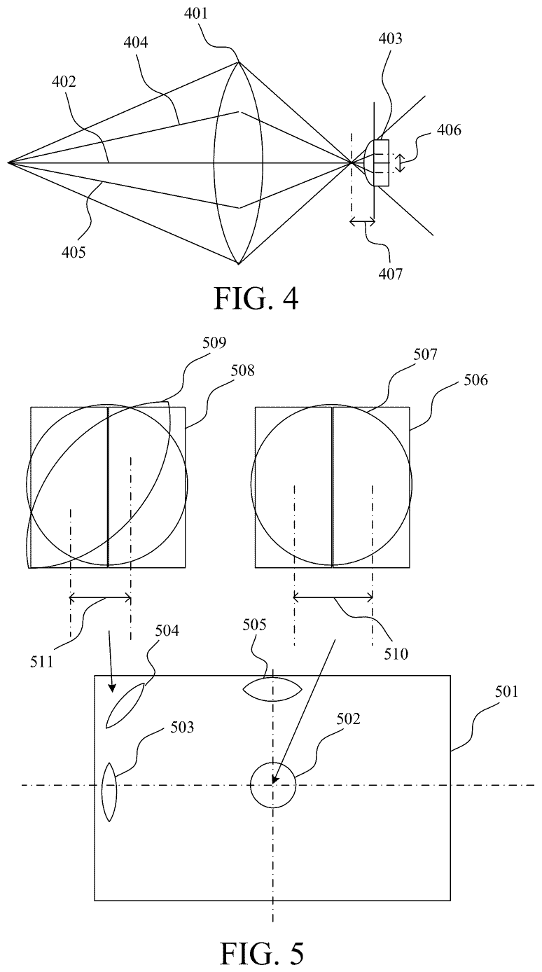

A description will now be given of a relationship among a pixel position, a base length, and a light shield shape with reference to FIG. 5. FIG. 5 explains the light shield shape. Reference numeral 501 illustrates the image sensor 202 viewed from the front side. Reference numeral 507 denotes a shape of a pupil (exit pupil) when the imaging optical system 201 is viewed from a central portion 502 of the image sensor 202. Reference numeral 510 denotes a base length at pixel 506. Reference numeral 509 denotes an exit pupil shape at a diagonal portion 504 of the image sensor 202.

The imaging optical system 201 has a combination of a plurality of lenses in a barrel shape, so when viewed from the central portion 502, the centers of the lens frames are aligned with a straight line. However, as the distance from the optical axis (optical axis center) increases, a shift occurs according to the distance of the lens from the imaging surface, and the exit pupil at the diagonal portion 504 has the light shield shape 509 due to the resultant light shield. Thereby, the base length 511 reduces at the pixel 508.

The light shield shape concentrically changes for the optical axis, but the divided pixels are divided in the left and right. Therefore, the pixel and the angle of the light shield shape differ according to the pixel position. The pixel unit on the image sensor 202 is neither vertically symmetrical nor horizontally symmetrical because it has a structure other than the photoelectric converters 302 and 303. Manufacturing errors of the microlens 301 and the like are to be considered. Thus, the information required to calculate the base length is specific to the pixel position. Accordingly, this embodiment calculates a coefficient equivalent to the base length, using a parameter table according to the F-number and PO value (exit pupil distance) for each pixel position.

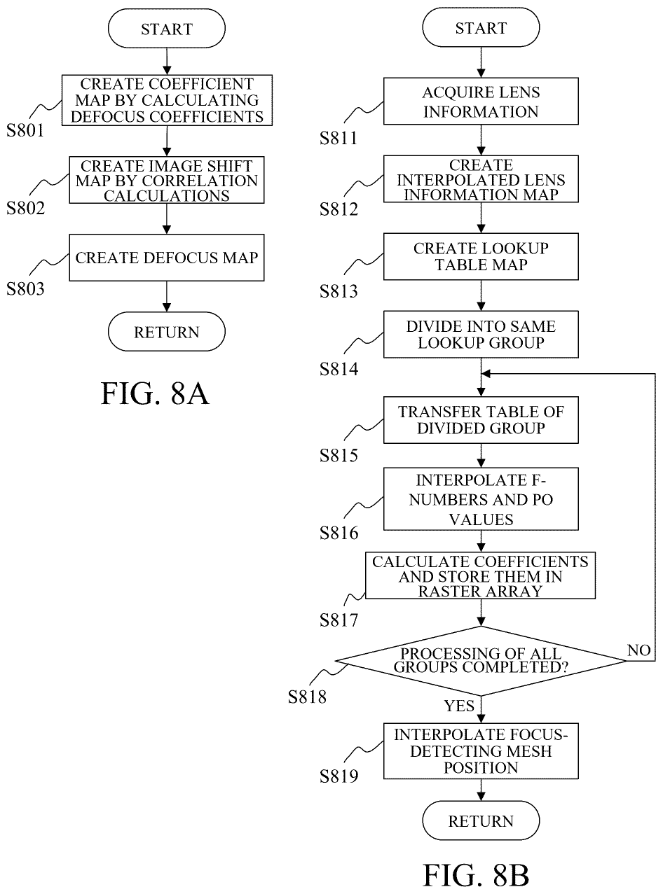

Referring now to FIG. 8A, a description will be given of a procedure for the focus detector 207 to create a defocus map. FIG. 8A is a flowchart illustrating the procedure for creating a defocus map. Each step in FIG. 8A is mainly executed by the focus detector 207.

In a case where the process of creating a defocus map starts, first in step S801, the focus detector 207 calculates a defocus coefficient and creates a coefficient map. The coefficient map can be created once the state of the imaging optical system 201 is determined, so it may be created in parallel with exposure. Next, in step S802, the focus detector 207 reads out the exposed A and B image signals from the DRAM 203, performs correlation calculations, and creates an image shift map. Next, in step S803, the focus detector 207 creates a defocus map by multiplying the image shift map created in step S802 by the coefficient map created in step S801.

Referring now to FIG. 8B, a detailed description will be given of the procedure for creating the coefficient map in step S801. FIG. 8B is a flowchart illustrating the procedure for creating the coefficient map. First, in step S811, the focus detector 207 acquires lens information (information regarding the imaging optical system 201). Next, in step S812, a lens information map (interpolated lens information map) is created.

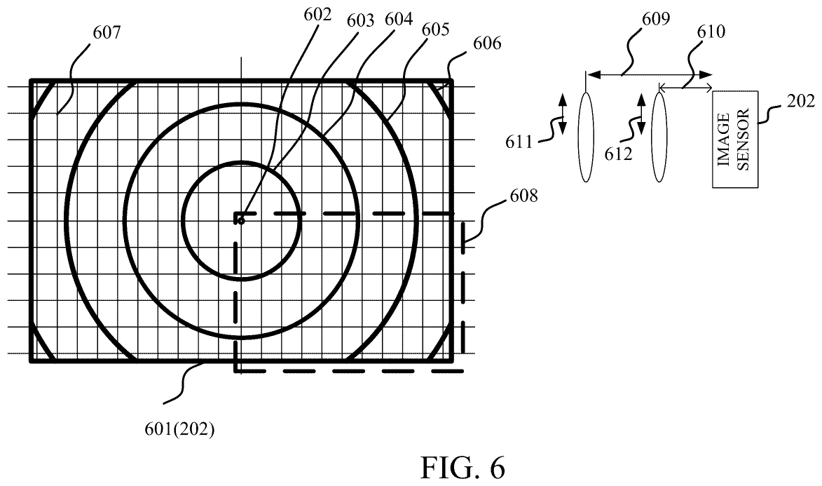

Referring now to FIG. 6, a detailed description will be given of the procedure for acquiring lens information in step S811 and creating the lens information map in step S812. FIG. 6 explains a position on the imaging surface and the lens information.

Reference numeral 601 denotes a front view of the image sensor 202, reference numeral 602 denotes the optical axis, and reference numerals 603 to 606 indicate discrete distances from the optical axis 602, corresponding to distances that have discrete parameters of the lens (imaging optical system 201). With the parameters of the distances 603 to 606, the parameter at a point between them can be created by interpolating the left and right points. Reference numeral 610 denotes a distance between the first lens frame and the image sensor 202, reference numeral 612 denotes a radius of the first lens frame, reference numeral 609 denotes a distance between the second lens frame and the image sensor 202, and reference numeral 611 denotes a radius of the second lens frame. As far as these four pieces of information (parameters) are obtained from the lens (imaging optical system 201), the light shield shape at the pixel position can be calculated.

Since the lens frame itself is provided in the space distorted by the refraction of the lens, the distance to the lens frame and its radius differ according to the pixel position. Therefore, it is to obtain parameters corresponding to the current lens state regarding the optical axis 602 and the distances 603 to 606 as the four pieces of information (parameters).

In this embodiment, since the interchangeable lens includes the imaging optical system 201 and thus possesses these four pieces of information, this information is transferred from the interchangeable lens to the camera body by communication. A grid 607 indicates a position where the coefficient parameter table exists. The coefficient parameter table is a table corresponding to the position where the grid 607 intersects. This table has information on the entire screen discretely, but the four frame information is obtained by interpolation using the distance from the optical axis 602. Therefore, if only one-quarter of the screen is interpolated, the interpolation results for the other three pieces of information that have the same distance from the optical axis 602 can be shared. The lens information map calculated in step S812 is a map of only the area surrounded by a dashed line 608.

The focus detector 207 has index data, which indicates the correspondence between distance order data from the optical axis 602 of the entire screen and the lens information map of one-quarter of the screen, in distance order from the optical axis 602, and accesses the lens information map by looking up (referring to) the index data.

In step S812, the focus detector 207 creates a lens information map (interpolated lens information map). More specifically, the focus detector 207 first obtains the distance to the two lens frames and their radii by interpolation, and then calculates the size and distance of the exit pupil. The lens information map is a map of the F-number regarding the size of the exit pupil and the PO value regarding the distance to the exit pupil (exit pupil distance) for each pixel position.

Next, in step S813, the focus detector 207 creates a lookup (reference) table map using the lens information map created in step S812. Next, in step S814, the focus detector 207 divides the lookup table map created in step S813 into the same lookup group.

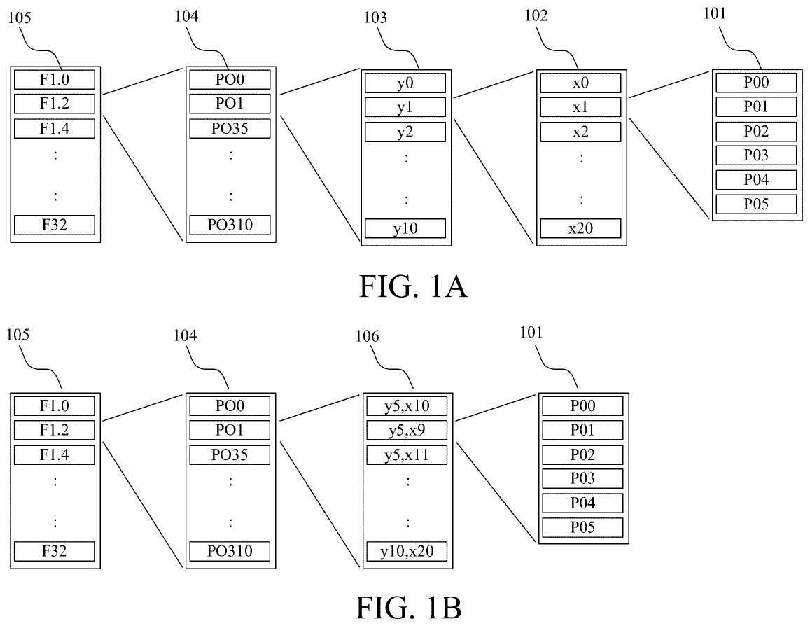

Referring now to FIGS. 1A and 1B, a description will be given of the data array order stored in a memory such as the DRAM 203 or the ROM 209, that is, the order from the optical axis to the periphery. This embodiment will be described in the order from the optical axis to the periphery, but is not limited to this example, and can also be applied to an order from the periphery to the optical axis. FIG. 1A illustrates an array in a general raster order in a comparative example. FIG. 1B illustrates an array in this embodiment (in order from the optical axis to the periphery, i.e., an array in a spiral order based on the optical axis).

Reference numeral 101 denotes parameters P00 to P05 corresponding to pixel position (y1, x1). Reference numeral 102 denotes an array of parameters 101 in which pixels are arranged horizontally and adjacently in order (horizontal pixel positions x0 to x20). Reference numeral 103 denotes an array of parameters 101 in which pixels are arranged vertically and adjacently in order (vertical pixel positions y0 to y10). The arrays 102 and 103 form one surface (the imaging surface of image sensor 202). This is a typical array for image data, etc. Reference numeral 104 denotes an array (PO0 to PO310) in which the surfaces (arrays 102, 103) are arranged in PO order. Reference numeral 105 denotes an array (F1.0 to F32) in which the surfaces (arrays 102 and 103) are arranged in F-number order. The arrays 104 and 105 are second arrays (arrays in order of a value regarding the optical condition) regarding the optical condition (F-number, PO value, etc.).

FIG. 1A illustrates parameters 101 at pixel position (y1, x1) under the conditions of the F-number of F1.2 and the PO value of PO1. In FIG. 1A, the first pixel position is the pixel position (y0, x0) on the optical axis.

FIG. 1B illustrates an array (first array) 106 in this embodiment. The first pixel position is not (y0, x0), but (y5, x10), i.e., the pixel position on the optical axis, as the first data, followed by pixel positions (y5, x9) and (y5, x11) on the left and right of the optical axis, in order of proximity to the optical axis. The memory in this embodiment stores first data in which information for each pixel position of the image sensor 202 is stored in a first array in the order from the optical axis of the imaging optical system 201 toward the periphery, and second data in which the first data is stored in a second array regarding the optical condition. As described below, the focus detector 207 calculates third data (coefficient data) using a part of the first data in the second data, which are a plurality of consecutive adjacent data, and stores in the memory the third data in a third array (raster array) different from the first array.

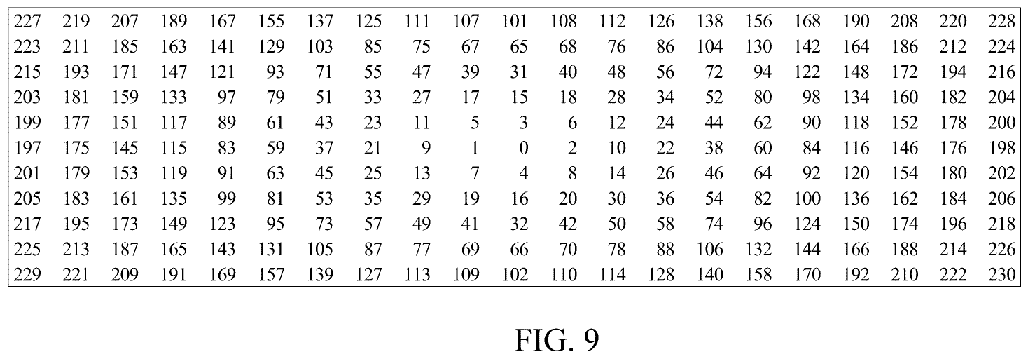

FIG. 9 explains an array order (an order of the array 106) corresponding to the pixel positions in this embodiment, and illustrates array positions for positions on the screen (horizontal pixel positions x0 to x20 and vertical pixel positions y0 to y10). The central pixel position is “0,” the pixel positions to the left and right of it are “1” and “2,” and then the pixel positions above and below it are “3” and “4.” The final pixel positions “227,” “228,” “229,” and “230” are located at the diagonal parts (four corners) of the screen

Since the F-numbers are discrete and PO values are discrete, four parameters are to be obtained for interpolation. For example, in a case where the F-number is F1.3 and the PO value is 20, interpolation is performed using the four parameters “F1.2, PO1,” “F1.2, PO35,” “F1.4, PO1,” and “F1.4, PO35.”

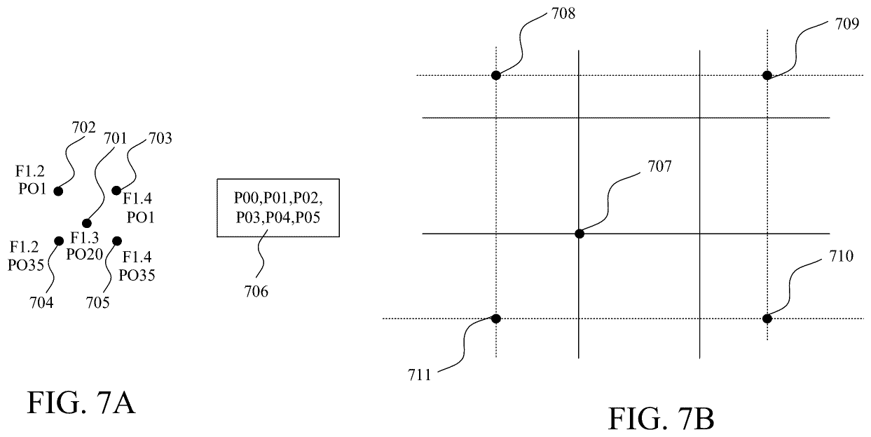

FIGS. 7A and 7B explain interpolation in this embodiment. In FIG. 7A, reference numeral 706 denotes a set of parameters (corresponding to parameter 101), and reference numerals 702, 703, 704, and 705 denote parameters obtained from a table, and are four points each having six parameters 706. In a case where the conditions corresponding to point 701 to be obtained are F1.3 and PO20, the six parameters 706 corresponding to point 701 are obtained by interpolation using the parameters 706 corresponding to these four surrounding points 702, 703, 704, and 705.

The lookup table map created in step S813 in FIG. 8B includes data in which four lookup destinations of discrete data for interpolating F-numbers and PO values are arranged in a distance order from the optical axis. In a case where the discrete value crosses a threshold value, the four combinations change, but the F-numbers and PO values gradually change as they move away from the optical axis. Thus, an array in distance order from the optical axis increases the probability that adjacent data have the same lookup destination.

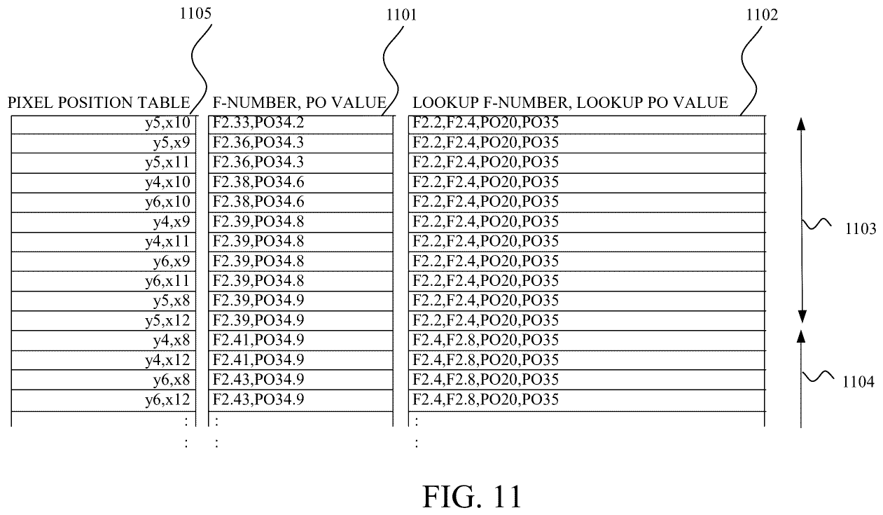

Referring now to FIG. 11, a description will be given of the lens information map created in step S812 and the lookup table map created in step S813. FIG. 11 explains the pixel position table, F-numbers and PO values, and lookup (reference) F-numbers and PO values.

Reference numeral 1101 denotes the lens information map (F-numbers and PO values) created in step S812, and includes information about each pixel in the pixel position table 1105. The F-numbers and PO values change gradually as the distance from the optical axis (the center position of the image sensor 202) increases. Pixels that are the same distance from the center position have the same value, so if the pixel is located on the optical axis (center) in either the vertical or horizontal direction, two consecutive pixels have the same value. In a case where the pixel is located differently from the optical axis (center) in either the vertical or horizontal direction, four consecutive pixels have the same value.

Reference numeral 1102 denotes a lookup table map (lookup F-number and lookup PO value) created in step S813, and indicates the value of discrete data that is used for interpolation. In area 1103, the lookup table map 1102 has a lookup data set that includes lookup data common to corresponding pixels. In area 1104, the lookup table map 1102 has a lookup data set that includes lookup data different from the lookup data in area 1103. In step S814, the focus detector 207 classifies the lookup table map into groups, such as areas 1103 and 1104, and creates management data for the start and consecutive number of each lookup group (divided group) (divided into the same lookup group).

Next, in step S815, the focus detector 207 DMA-transfers a parameter table corresponding to one of the divided groups from the DRAM 203 to an internal calculation memory in the focus detector 207. Next, in step S816, the focus detector 207 interpolates parameters based on the F-number and PO value, as described with reference to FIG. 7A. Next, in step S817, the focus detector 207 calculates a defocus coefficient (conversion coefficient) using the parameters for which the interpolation has been completed. The calculation equation for the defocus coefficient is not the essence of this embodiment, so a description thereof will be omitted here, but can use, for example, an equation such as that illustrated in Japanese Patent Laid-Open No. 2019-219576.

The focus detector 207 then stores the obtained defocus coefficient (coefficient data) in a corresponding location in the memory unit in the order of the raster array (in the horizontal or vertical order of pixels, third array). The memory stores a pixel position table 1105 that associates a position on the array in the distance order from the optical axis (position in the first array) with a position in the raster array (position in the third array). The focus detector 207 looks up the pixel position table 1105 and stores the coefficient data obtained by calculation in the order of the first array, in the raster array in the memory.

Next, in step S818, the focus detector 207 determines whether the defocus coefficients corresponding to all groups (all pixel positions) have been stored in a raster array (whether processing for all groups has been completed). In a case where there are defocus coefficients that have not yet been stored, the flow returns to step S815, and the focus detector 207 performs processing for the next parameter table. Repeating steps S815 to S814 enables the defocus coefficients corresponding to all pixel positions to be stored in the raster array. In a case where all defocus coefficients have been stored, the flow proceeds to step S819.

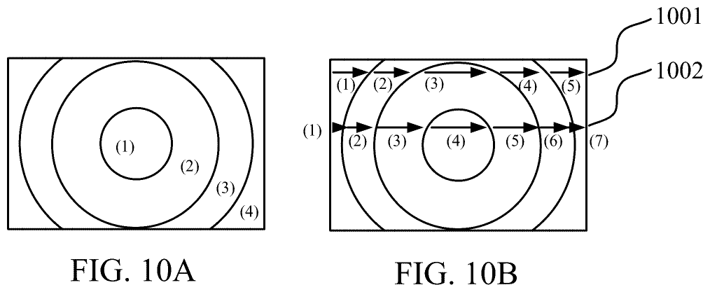

Referring now to FIGS. 10A and 10B, a description will be given of a difference in the number of transfers between a raster array and an array in the distance order from the optical axis (spiral order). FIGS. 10A and 10B explain the difference between the raster array and the array in the distance order from the optical axis. FIG. 10A illustrates blocks (same lookup group) divided in step S814. In the example illustrated in FIG. 10A, there are 16 transfers, i.e., 4 times ((1) to (4)) ×4 types. FIG. 10B illustrates transfers in the case of the raster array. Just transferring line 1001 requires 20 transfers, i.e., 5 times ((1) to (5))×4 types, which exceeds the number of transfers in FIG. 10A. Line 1002 requires 28 transfers, i.e., 7 times ((1) to (7))×4 types. Thus, in the case of the raster array illustrated in FIG. 10B, the position and number of lines differ for each line.

Next, in step S819, the focus detector 207 performs interpolation at the focus-detecting mesh position. Up until step S818, a mesh is formed with a density necessary to secure accuracy. Focus detection is to be performed with finer accuracy. Thus, the density of the image shift map created in step S802 is higher than the density of the defocus coefficients of the raster array created in step S817.

Points 708, 709, 711, and 710 in FIG. 7B correspond to the pixel positions of the coefficient map created in step S817. Point 707 in FIG. 7B corresponds to the pixel position of the image shift map created in step S802. In step S819, the focus detector 207 creates a defocus coefficient map corresponding to the pixel position of the image shift map by interpolating values from distances between each of points 708, 709, 711, and 710 and point 707. In order to create the coefficients to be multiplied by the image shift map in the raster array by interpolation, it is to previously store the defocus coefficients in the raster array in step S817.

In this embodiment, the pixel position table 1105 is expressed by the vertical and horizontal indexes of the pixels, but similar effects can be obtained by expressing it by offset information on the memory address of the storage destination.

In this embodiment, the parameters are managed by the F-number and PO value, but similar effects can be obtained by other values as long as they are values regarding information representing the exit pupil shape, such as the upper and lower lines.

This embodiment calculates the defocus coefficient, but is not limited to this example. For example, similar effects can be obtained by calculating a point spread function or line spread function associated with the exit pupil and performing deconvolution processing using a restoration filter as disclosed in Japanese Patent Application Laid-Open No. 2012-65187.

This embodiment configures the lens information map 1101 in the distance order from the optical axis over the entire screen, but is not limited to this example. For example, an intermediate effect can be obtained by configuring the inside of a divided area divided into blocks or the inside of one line of a raster in the distance order from the optical axis.

This embodiment controls the focus detector 207 using a microcomputer (processor), but similar effects can be obtained by using dedicated hardware.

### SECOND EMBODIMENT

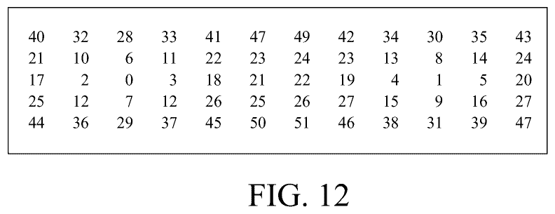

Referring now to FIG. 12, a description will be given of a second embodiment of the present disclosure. FIG. 12 explains the array order corresponding to pixel positions, and illustrates the array position relative to the position on the screen (pixel position).

In recent years, as disclosed in Japanese Patent Laid-Open No. 2023-42434, an interchangeable lens configured to form a stereoscopic image on a single image sensor has been reduced to practice. The imaging optical system for acquiring a stereoscopic image in Japanese Patent Laid-Open No. 2023-42434 is considered to have two optical axes (a plurality of optical axes). FIG. 12 corresponds to FIG. 9 described in the first embodiment, and illustrates an order assigned to a distance from each optical axis in a case where the imaging optical system has two optical axes as in this embodiment. As illustrated in FIG. 12, the first array in this embodiment is an array in the order from each of the two optical axes toward the periphery or from the periphery toward each of the plurality of optical axes (array in the spiral order based on each optical axis).

Just as the lens information map created in step S812 in the first embodiment is a quarter of the entire screen, this embodiment can reduce the lens information map to one-eighth by configuring eight locations at the same distance from the optical axis.

Each embodiment can provide a data structure and a calculation procedure that can reduce DRAM transactions for looking up a table based on the optical condition. Therefore, each embodiment can provide a processing apparatus, an image pickup apparatus, a processing method, and a storage medium, each of which can provide high-speed processing.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

This application claims priority to Japanese Patent Application No. 2024-064905, which was filed on Apr. 12, 2024, and which is hereby incorporated by reference herein in its entirety.

What is claimed is:

1. A processing apparatus comprising:
a memory storing first data, in which information for each pixel position on an image sensor is stored in a first array in an order from an optical axis of an imaging optical system toward a periphery or from the periphery toward the optical axis, and second data, in which the first data is stored in a second array regarding an optical condition; and
a processor configured to:
calculate third data using a plurality of consecutive adjacent data of a part of the first data in the second data, and
store in the memory the third data in a third array different from the first array.

2. The processing apparatus according to claim 1, wherein the memory stores a pixel position table that associates a position in the first array and a position in the third array with each other, and
wherein the processor is configured to look up the pixel position table, and store in the memory the third data in the third array obtained by calculation in an order of the first array.

3. The processing apparatus according to claim 1, wherein the imaging optical system has a plurality of optical axes, and
wherein the first array is an array in an order from each of the plurality of optical axes toward the periphery or an order from the periphery toward each of the plurality of optical axes.

4. The processing apparatus according to claim 1, wherein the first array is an array in a spiral order based on the optical axis.

5. The processing apparatus according to claim 1, wherein the second array is an array in an order of a value regarding the optical condition.

6. The processing apparatus according to claim 5, wherein the value regarding the optical condition includes at least one of an F-number and a PO value.

7. The processing apparatus according to claim 1, wherein the third array is an order in a horizontal or vertical direction of pixels.

8. The processing apparatus according to claim 1, wherein the third data is coefficient data that is used to calculate a defocus amount.

9. The processing apparatus according to claim 1, wherein the processor is configured to:
calculate an image shift amount using a first focus detecting signal generated from a light receiving signal of a first focus detecting pixel configured to receive a light beam passing through a first pupil partial area in the imaging optical system, and a second focus detecting signal generated from a light receiving signal of a second focus detecting pixel configured to receive a light beam passing through a second pupil partial area in the imaging optical system that is different from the first pupil partial area, and
calculate a defocus amount using the image shift amount and the third data.

10. An image pickup apparatus comprising:
an image sensor; and
a processing apparatus,
wherein the processing apparatus includes:
a memory storing first data, in which information for each pixel position on an image sensor is stored in a first array in an order from an optical axis of an imaging optical system toward a periphery or from the periphery toward the optical axis, and second data, in which the first data is stored in a second array regarding an optical condition; and
a processor configured to:
calculate third data using a plurality of consecutive adjacent data of a part of the first data in the second data, and
store in the memory the third data in a third array different from the first array.

11. A processing method comprising:
looking up first data stored in a memory, in which information for each pixel position on an image sensor is stored in a first array in an order from an optical axis of an imaging optical system toward a periphery or from the periphery toward the optical axis, and second data stored in the memory, in which the first data is stored in a second array regarding an optical condition;
calculating third data using a plurality of consecutive adjacent data of a part of the first data in the second data; and
storing in the memory the third data in a third array different from the first array.

12. A non-transitory computer-readable storage medium storing a program that causes a computer to execute the processing method according to claim 11.
